(19) United States
(12) Patent Application Publication
(10) Pub. No.: US 2015/0004584 A1
(43) Pub. Date: Jan. 1, 2015

(54) MODULAR PATIENT SIMULATING MANNEQUIN AND METHOD THEREOF

(71) Applicant: CAE Healthcare Canada, Saint-Laurent (CA)

(72) Inventors: Michel Galibois, Rosemere (CA); Yanick Cote, Lachine (CA); Jeffery Jacoby, Bradenton, FL (US); Louis Diotte, Laval (CA)

(73) Assignee: CAE Healthcare Canada, Saint-Laurent (CA)

(21) Appl. No.: 14/231,306

(22) Filed: Mar. 31, 2014

Related U.S. Application Data
(60) Provisional application No. 61/841,305, filed on Jun. 29, 2013.

(51) Int. Cl. G09B 23/34; G09B 23/28

(52) U.S. Cl. CPC G09B 23/34; G09B 23/281
USPC 434/270; 434/267

(57) ABSTRACT

The present disclosure relates to a patient-simulating mannequin, which comprises at least one main smart board card. The main smart board card stores simulation scenarios. The patient-simulating mannequin also comprises at least one removable body part module having at least one peripheral smart board card in communication with the main smart board card. In another aspect, the present disclosure relates to a method for assembling a patient-simulating mannequin. The method comprises selecting a physiologic model and a simulation scenario. The method then determines removable body parts required to reproduce the physiologic model and run the simulation scenario. Removable body parts required to run the simulation scenario are then selected and connected to at least one main smart board card. Each body part comprises a peripheral smart board card. Then, the content of the main smart board card is updated and the simulation is run.

The present disclosure relates to a patient-simulating mannequin for healthcare training.

### BACKGROUND

Patient-simulating mannequins are used in the medical field to train paramedics, nurses, and doctors to deliver first aid to injured patients. In order to simulate the traumas with greater realism, the patient-simulating mannequin is shaped to resemble to a human and is conceived to reproduce some of the physiological behaviors and pathologies of a human. For example, the patient-simulating mannequin may bleed, speak, shake, convulse, blink eyes, respond to application of pressure or even include a vascular system.

Although the current range of patient-simulating mannequins may share similar aesthetic form and basic functionalities, there is little commonality in the hardware used. Therefore, patient-simulating mannequins typically represent and comprise body parts that are not compatible and/or reusable on another patient-simulating mannequin. Thus each patient-simulating mannequin is typically designed to simulate a very small subsets of physiological behaviors and pathologies of a human.

Therefore, there is a need for a patient-simulating mannequin comprising interchangeable body parts that can be added or removed at the convenience of a user or a simulation scenario.

### SUMMARY

In a first aspect, the present description relates to a patient-simulating mannequin. The patient-simulating mannequin comprising at least one main smart board card and at least one body part module. The at least one main smart board card operating the patient-simulating mannequin and storing simulation scenarios to be used with the patient-simulating mannequin. The at least one body part module is removable from the patient-simulating mannequin, and has at least one peripheral smart board card in communication with the main smart board card. The at least one peripheral smart board card is configurable by the at least one main smart board card.

In another aspect, the present disclosure relates to a method for assembling a patient-simulating mannequin. The method comprises selecting a physiologic model and a simulation scenario. The method further determines removable body parts required to reproduce the physiologic model and run the simulation scenario. The method then selects the removable body parts, each body part including a peripheral smart board card, and one of the selected removable body parts further including a main smart board card. The method continues with mechanically inter-connecting the selected removable body parts, actuating the main smart board card and the peripheral smart board cards of each body part. The method proceeds to configure the peripheral smart board card of each body part by the main smart board card. The method also updates the content of the main smart board card, and then runs the simulation.

### BRIEF DESCRIPTION OF THE DRAWINGS

In the appended drawings:

FIG. 1 is a block diagram of a patient-simulating mannequin;

FIG. 2 is an example of an exploded perspective view of the patient-simulating mannequin of FIG. 1;

FIG. 3 is a block diagram of a smart board card;

FIG. 4 is an exemplary functional model of the smart board card of FIG. 3;

FIG. 5 is a block diagram of an example of a system providing a simulation scenario; and

FIG. 6 is a graphical representation of a user/instructor interface to access and transmit data from and to the patient-simulating mannequin.

### DETAILED DESCRIPTION

The foregoing and other features will become more apparent upon reading of the following non-restrictive description of illustrative embodiments thereof, given by way of example only with reference to the accompanying drawings. Various aspects of the present disclosure generally address one or more of the problems of simulating a human patient and modularity.

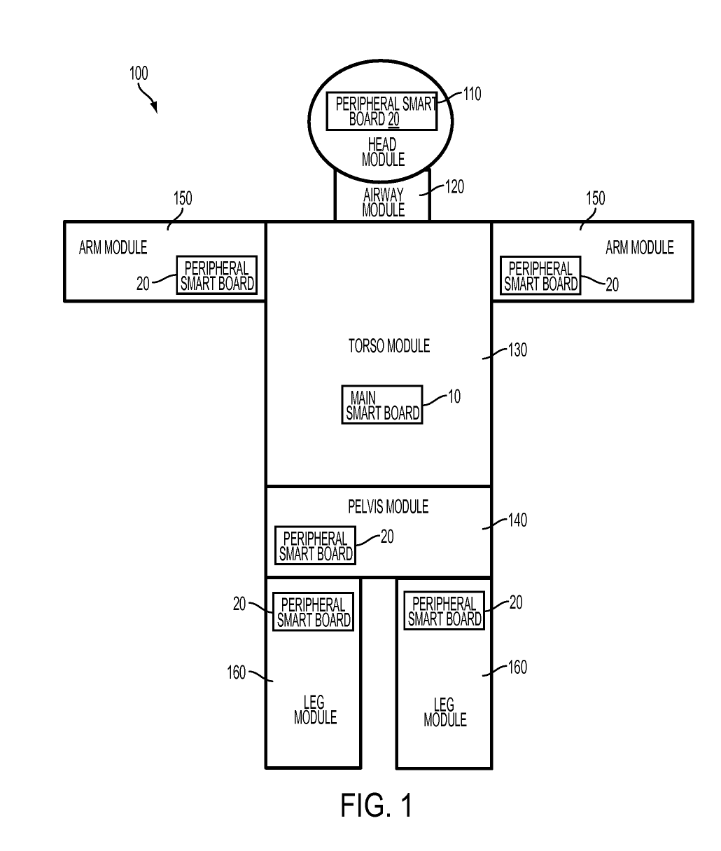

Referring now to the drawings, FIG. 1 is a functional block diagram of a patient-simulating mannequin 100. The patient-simulating mannequin 100 comprises various removable body parts required to achieve a medical scenario representative of a human physiological function and/or pathology. The patient-simulating mannequin 100 represented in FIG. 1 comprises a torso module 130, two arm modules 150, a pelvis module 140, two leg modules 160, an airway module 120 and a head module 110. The number of modules, the type of modules, the interchangeability and/or removability, as well as the size and shape of the modules, may vary based on the types of medical scenario to be simulated. In the present example, the torso module 130, the two arm modules 150, the pelvis module 140, the two leg modules 160, the airway module 120 and the head module 110 are removable and could be replaced by other modules adapted for simulating other physiological functions and/or pathologies. In another embodiment of the patient-simulating mannequin 100, the patient-simulating mannequin 100 may be a partial patient-simulating mannequin comprising only the upper body parts (i.e. the torso module 130, the two arm modules 150, the airway module 120 and the head module 110).

The patient-simulating mannequin 100 of FIG. 1 is used only to graphically represent examples of some of the modules, which can be combined to form a patient-simulating mannequin, and not to provide any indication of the shape, size, inter-functionalities and/or intra-functionalities. Many more modules could be added to the patient-simulating mannequin 100, such as a breathing module, a liver module, a pancreas module, a stomach module, intestines module, hearth module, vascular module, hearing module, etc., and some of the modules could be sub-divided into smaller modules, i.e. the arm modules could be divided in forearm modules, wrist modules, hand modules, etc.

The patient-simulating mannequin 100 also comprises one or more main smart board cards 10 for coordinating operation of the patient-simulating mannequin 100. Each main smart board card 10 stores simulation scenarios to be used with the patient-simulating mannequin 100. In FIG. 1, the main smart board card 10 is located in the torso module 120; however, the main smart board card 10 could be located anywhere within the patient-simulating mannequin 100. Each removable module comprises one or more peripheral smart board card(s) 20 in communication with the main smart board card 10. The main smart board card(s) and peripheral smart board cards will be described in more detail below.

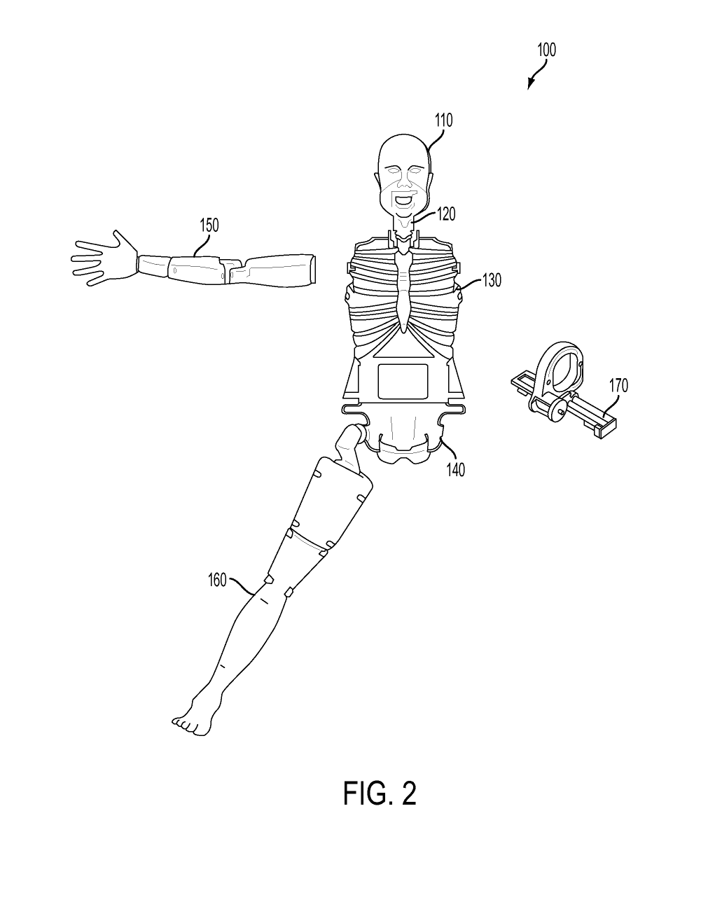

Referring now to FIG. 2, there is depicted a graphical representation of the exploded patient-simulating mannequin 100 which comprises the following removable modules: the head module 110, the airway module 120, the torso module 130, the pelvis module 140, one arm module 150, one leg module 160 and a childbirth mechanism 170. The patient-simulating mannequin 100 can include an additional arm module 150 and/or leg module 160 to reproduce a human body with all four members. In the interest of clarity, in the present example, the arm module 150 comprises a hand and its fingers; and the leg module 160 comprises a foot and its toes, but the present patient-simulating mannequin 100 is not limited to such an implementation. It is also understood that each of the body part modules and sub-body part modules forming the patient-simulating mannequin 100 may comprise its own peripheral smart board card (although not shown in FIG. 2 for simplicity purposes) directly and or ultimately connected to the main smart board card to actuate and control the body parts modules so as to simulate training scenarios and human physiological functions and/or pathologies.

Referring back to FIG. 1 and concurrently to FIG. 2, the patient-simulating mannequin 100 comprises a torso module 130, which comprises the main smart board card 10. It can be understood that the main smart board card can be located elsewhere in the patient-simulating mannequin 100. The main smart board card 10 may be connected by means of electric or optic connections, or wirelessly to the peripheral smart board card(s) 20, or by a combination of both. The torso module 130 is also in mechanical and/or electrical connection with the airway module 120. The airway module 120 is also in mechanical and/or electrical connection with the head module 110. The torso module 130 is in turn in mechanical and/or electrical connection with the arm module(s) 150 and the pelvic module 140. The pelvic module 140 is further in mechanical and/or electrical connection with the leg module(s) 160.

The airway module 120 comprises at least one peripheral smart board card 20 (not represented in FIG. 1) in communication with the main smart board card 10. The head module 110 comprises at least one peripheral smart board card 20 in direct communication with the main smart board card 10 or in ultimate communication with the main smart board card 10 through the at least one peripheral smart board card 20 located in the airway module 120. The main smart board of the torso module 130 may further be in communication with the peripheral smart boards of the other body parts, such as for example the airway module 120, the pelvic module 140, the arm module(s) 150 and the leg module(s) 150. The arm module 150 comprises at least one peripheral smart board card 20 in communication with one of: the main smart board card 10 and the at least one peripheral smart board card 20 located in the torso module 130. In addition to the main smart board card 10, the body part hosting the main smart board card 10, i.e. in FIG. 1 the torso module 130, may also comprise at least one peripheral smart board card 20 (not represented in FIG. 1) in communication with the main smart board card 10. Alternatively, the body part hosting the main smart board card 10, in the present instance the torso module 130, may comprise an integrated smart board card (not shown) simultaneously implementing the functionalities of the main smart board card 10 and the peripheral smart board card 20.

The torso module 130 is also mechanically and/or electrically connected to the pelvic module 140. The pelvic module 140 comprises at least one peripheral smart board card 20 in communication with one of: the main smart board card 10 and the at least one peripheral smart board card 20 located in the torso module 130. The pelvic module 140 provides the possibility to configure the patient-simulating mannequin 100 so as to more realistically simulate a male or a female patient. For instance, the torso module 130 may be adapted to receive a childbirth mechanism 170 (not represented in FIG. 1) to deliver a fetal simulator. Therefore, the pelvic module 140 could further be adapted to receive a uterine module (not represented in the Figures) to simulate a realistic childbirth procedure or scenario. The childbirth mechanism 170 could be swapped with an ultrasound or surgical simulation assembly. Alternatively and or concurrently, the torso module 130 may further receive or comprise a lung module (not represented in the Figures) with a momentary negative pressure inspiration trigger which might be improved by adding CO2 injection or altogether replaced with a lung module with a full inspiratory/expiratory control.

The pelvic module 140 is in mechanical and/or electrical connection with the leg module 160. The leg module 160 comprises at least one peripheral smart board card 20 in communication with one of: the main smart board card 10 and the at least one peripheral smart board card 20 located in the pelvic module 140.

An exoskeleton framework defined by the intersected volumes of the male and female forms encapsulates the largest contiguous spaces possible. Beyond conduciveness to packaging flexibility, mounting surface area is maximized for easing assembly and service.

The modules of the patient-simulating mannequin 100 can be made of various material compositions to reproduce realistic training experience. For example, using a soft skin and underlying filler layer creates a natural feel and, by varying the thickness of the filler, allows the portrayal of different genders and body types. Extending alterations to the skin itself yields ethnic variation. Other properties that may be considered when selecting materials for manufacturing of the modules of the patient-simulating mannequin 100 include, for example, allergenic properties, ultraviolet resistance, colorability, part manufacturability, and cost.

The mechanical, fluid, pneumatic and/or electrical connections between the modules and/or body parts can be made within hollow joints which provide the proper range of motion while protecting tubes and wires from pinching while allowing mechanical, fluid, pneumatic and/or electrical connection there between. Conduits and channels throughout the cavities of the body parts of the patient-simulating mannequin further protect the mechanical, fluid, pneumatic and electrical components from contact with edges and heat sources. Alternatively, the mechanical, fluid, pneumatic and/or electrical connections can be made of any types of components known in the art such as tubes, pipes, clips, cables, latches, joints, screws, etc. or any combination thereof.

Accommodation for amputation and installation of alternate prostheses is present in each body part. Separation points use multiple conductor, hybrid tube/wire, and blind mate connectors where possible.

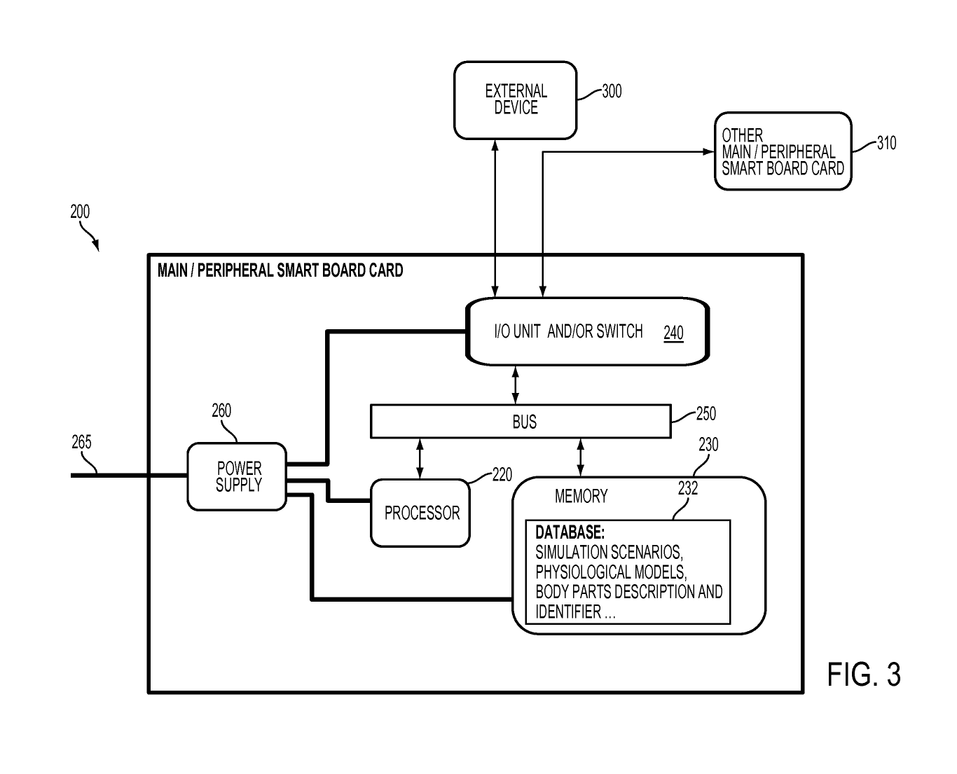

Reference is now made to FIG. 1 and concurrently to FIG. 3. FIG. 3 is a block diagram showing the content of a smart board card 200, which could act as a main smart board card, peripheral smart board card or integrated smart board card. The smart board card 200 illustrated in FIG. 3 corresponds to an instance of either one of a main smart board card 10 or a peripheral smart board card 20 represented in FIG. 1. The smart board card 200 operates similarly to a board computer to interface external devices 300 and other smart board cards, which can be inter-connected via a wired or wireless connection. Each peripheral smart board card 20 of a body part (e.g. removable leg module 160) is in communication with one of the main smart board card 10 or another peripheral smart board card 20 located in the body part through which it is connected (e.g. pelvic module 140). A peripheral smart board card 20 can communicate with the main smart board card 10 or another peripheral smart board card 20 through a wired communication such as an Ethernet connection, a USB connection, a CAN bus connection; or through a wireless communication using radio waves such as a Wi-Fi connection, a WWAN connection, a Bluetooth™ connection, a Cellular network connection, etc.

The smart board card 200 comprises at least one memory 230. The memory 230 stores a database 232. The database 232 may include any of the following types of data: simulation scenarios, physiological models, instructions, body parts description, body part features and body part identifiers for the body parts in which the smart board 200 is installed. Alternatively, the previously mentioned types of data may be stored in the memory 230 in any way known in the art, either through a database, a database with registries, or registries alone. In the case of a main smart board card 10, the database 232 stores a table of body part identifiers (e.g. consisting of identifiers of peripheral smart board cards 20 associated with the features and functionality of the corresponding body part identifier). The memory 230 may include Random Access Memory, SD card, Micro SD card, Flash memory or similar element or combination thereof.

The smart board card 200 comprises at least one processor 220 for accessing the memory 230 and the database 232, operating the corresponding body part of patient-simulating mannequin 100 and running a simulation engine. The processor 220 can be a Microcontroller, CPU, GPU, FPGA or any similar element or combination thereof.

The smart board card 200 comprises an input/output (I/O) unit 240 for receiving data from a web client (software application) or any device in mechanical and/or electrical or wireless connection with the smart board card 200. The input/output unit 240 can be a Wi-Fi port, a Bluetooth™ port, a CAN Bus port, an Ethernet port, a USB port, an HDMI port, a switch or similar element or combination thereof that may achieve the purpose of connecting in a wired or wireless manner the smart board card 200 to other main or peripheral smart board card(s) 310 or to external communicating device(s) 300 to exchange any type of including digital data, images, videos and analog data.

The smart board card 200 also comprises a bus 250, electronically connected with the input/output unit 240, with the at least one processor 220, and with the at least one memory 230. The bus 250 provides electronic data exchange there between. The bus 250 may be replaced by direct electrical connections between the input/output unit 240, the at least one processor 220 and the at least one memory 230. The smart board card 200 further comprises a power supply 260 receiving an input power 265 (from an external power supply not represented in FIG. 3). The power supply 260 provides power to one or several electronic components of the smart board card 200 (e.g. processor 220, memory 230, I/O unit 240). Although not shown, the input power 265 could be directly used to power any of the components of the smart board card 200 when appropriate, without going through the power supply 260.

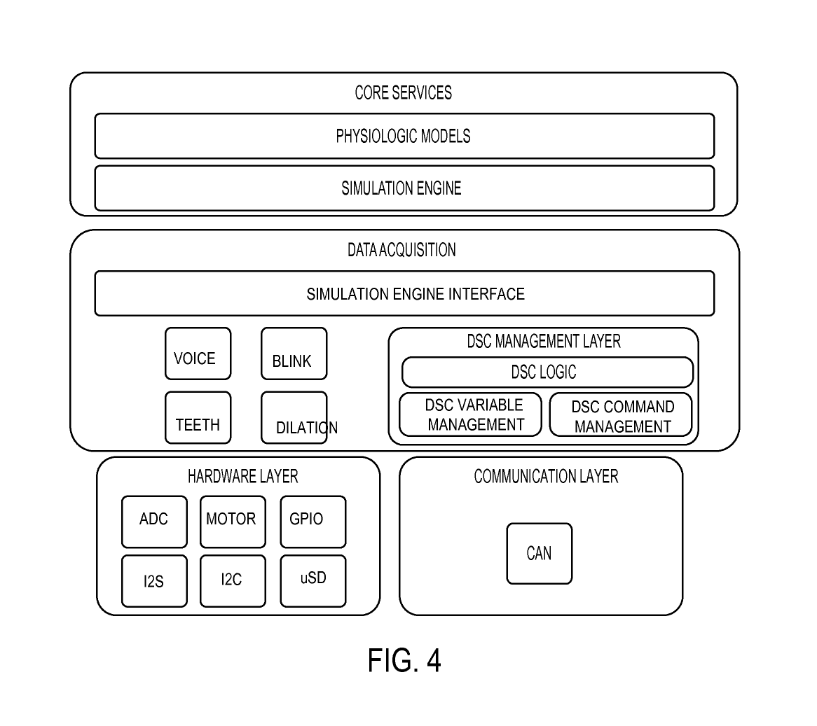

Referring to FIG. 4, the smart board card 200 can be functionally represented as a group of sub-functions, performed by the at least one processor 220, the at least one memory 230, the input/output unit 240, the bus 250 and power supply 260. The sub-functions may be grouped as follows: Core Services, Data Acquisition, Hardware Layer and Communication Layer. The Core Services include the Physiologic Models and Simulation Engine sub-functions. The Data Acquisition receives and forwards data to other smart board cards 200 and to components outside of the module in which the smart board card is integrated. The Data Acquisition may include a Distributed Sensor Card (DSC) Management Layer, which may include for example DSC Logic, a DSC Variable Management Function, and a DSC Command Management Function. The Hardware Layer may include any of the following: an Analog to Digital Converter (ADC), and a Digital to Analog Converter (DAC) for receiving/sending data/results, an Inter-Integrated Circuit (I2C), an Inter-IC Sound (I2S), a Pulse Width Modulation (PWM), a Serial Peripheral Interface (SPI), a GPI and a uSD. The Communication Layer may include a Controller Area Network (CAN) function.

The smart board card 200 provides modularity of the patient-simulating mannequin 100 and facilitates assembly, inspection, testing, debugging and service, while providing more flexibility. For instance, each body part can be built as a subassembly and tested apart from the complete patient-simulating mannequin 100. Then, a user can interface one of the body parts (e.g. removable arm module 150) with a wired or a wireless connection through the input/output unit 240 of the smart board card 20 integrated in the body part. The user can then run a series of predetermined tests to diagnose a malfunction or update instructions of a software program executed by the processor 220. Modularity also provides for the easy introduction of optional elements. With replaceable and interacting modules, a single patient-simulating mannequin 100 can be upgraded to enhance functionalities or expanded to support training in a wider range of specialties without the need to purchase another patient-simulating mannequin 100.

For instance, the ability to use the same airway simulation module 120 or a same eye simulation module (not represented in the Figures) in many (different) products reduces part number proliferation. It also bolsters production volumes, leveraging economies of scale. The complete airway simulation module 120 with all of its associated actuators for features like swollen tongue and laryngospasm is a complex assembly which need not be redeveloped for each new simulator model. Other examples of physiological functions that readily lend themselves to reuse across products are eye blinking, pupil dilation, pulse, chest movement, and lung mechanisms. While an eye assembly capable of eyeball movement might not share many parts with its fixed counterpart, an enhanced lung exhibiting improved resistance and compliance characteristics and full inspiration control could be created by recycling the resistive element and bellows of a lower functioning lung and combining them with a closed loop actuator.

The smart modular card 200 may further be configurable. Instances of the same configurable smart modular card are included in each removable body part, and configured by the main smart board card 10 or by a centralized configuration module (not shown) remotely located from the patient-simulating mannequin. Hardware and software components of a particular configurable smart modular card are configured to implement specific functionalities corresponding to a specific removable body part into which the particular configurable smart modular card is included. For example, a first configurable smart modular card located in the head module 110 is configured by the main smart board card 10 (via an exchange of configuration messages there between) to implement head-related functionalities; and a second configurable smart modular card located in the removable arm module 150 is configured by the main smart board card 10 (via an exchange of configuration messages there between) to implement arm-related functionalities. The main smart board card 10 may also be implemented with the same configurable smart modular card, specifically configured to play the role of a main smart board card. In this case, the main smart board card 10 is configured by an external device 300 (e.g. a configuring laptop or tablet), which is located outside of the patient-simulating mannequin 100 and has a network connection (wired or wireless) with the main smart board card 10.

The configurable smart modular card may include at least one of: a configurable I/O unit 240, a configurable power supply 260, and configurable simulation code. The configuration of the configurable smart modular card may consist of the following steps, executed in the same or a different order, and where some of the steps may not be present. A first step consists in configuring the I/O unit 240. The configuration of the I/O unit 240 may include a network configuration (e.g. IP address, Service Set Identifier (SSID) and wireless key for a Wi-Fi network). The configuration of the I/O unit 240 may also include specifying with which entities it is communicating (e.g. external device(s) 300 and other main/peripheral smart board card(s) 310). A second step consists in configuring the power supply 260. The power supply 260 provides power to electronic components of the configurable smart modular card (e.g. processor 220, memory 230, and I/O unit 240). The power supply 260 may also provide power to external components (e.g. sensors, actuators) located in the removable body part into which the configurable smart modular card is included. The configuration of the power supply 260 may include determining specific amperage and/or a specific voltage for the power delivered to a specific electronic component. A third step consists in configuring the simulation code executed by the processor 220. The simulation code may be divided in software modules implementing various functionalities and sub-functionalities of the patient-simulating mannequin 100. The configuration consists in determining which specific software module(s) are executed by the processor 220. The software modules are stored in the memory 230. Alternatively, some software modules may be downloaded from a central simulation code repository server.

The configurable smart modular card may also include auto-testing capabilities. For example, the processor 220 may execute testing software. The testing software may monitor at least one of the following: the configurable I/O unit 240 is operating according to the received configuration, the configurable power supply 260 is operating according to the received configuration, and the configurable simulation code executed by the processor 220 is operating according to the received configuration. The results of the tests are transmitted to the main central board card 10. The main central board card 10 coordinates the operations of multiple peripheral smart board cards 20 located in various removable body parts of the patient-simulating mannequin 100. Thus, the main central board card 10 determines an impact of a failure to a test reported by a specific peripheral smart board card 20. The impact may be one of the following: the impact is negligible and the whole simulation can carry on, the impact is fatal and the whole simulation must be interrupted, or the impact is not fatal and the simulation can carry on in a degraded mode (one or several removable body parts impacted by the failure are no longer used for the simulation).

The configurable input/output unit has a predefined output for sending a broadcast message and a predefined input for receiving a broadcast response message. The card comprises a bus electronically connected with the configurable input/output unit, the at least one processor and the at least one memory for providing electronic data exchange there between. The card comprises input/output configuration code stored in the memory. The input/output configuration code, when executed by the at least one processor, configures the plurality of inputs and outputs of the configurable input/output unit based on the broadcast response message. The card comprises a power supply. The power supply receives an entry power of a predetermined voltage and comprises a plurality of configurable power supply circuits. The card comprises power supply configuration code stored in the memory. The power supply configuration code, when executed by the at least one processor, configures the plurality of power circuits of the power supply based on the broadcast response message. The card comprises testing code stored in the memory. The testing code, when executed by the at least one processor, generates testing signals to the plurality of inputs and outputs of the configurable input/output unit configured based on the broadcast response message. The testing code further generates testing signals to the plurality of power circuits of the power supply configured based on the broadcast response message.

An exemplary method for assembling a modular training mannequin simulator involves the following steps, taken singly or concurrently, in whatever order depending on the situations:
1. Selecting a physiologic model from the database;
2. Selecting a simulation scenario from the database;
3. Determining removable body parts required to run the simulation scenario;
4. Selecting (Removing/Adding) removable body parts required to reproduce the physiologic model and run the simulation scenario, each body part including a peripheral smart board card, and one of the selected removable body parts further including a main smart board card;
5. Mechanically inter-connecting the selected removable body parts;
6. Actuating the main smart board card;
7. Actuating the peripheral smart board card of each body part;
8. Configuring the main smart board card 10 based on the selected physiologic model, simulation scenario and body parts required;
9. Establishing an electronic connection (Wired/Wireless) between the peripheral smart board card 20 of each body part and the main smart board card(s) 10;
10. Generating at the main smart board card a configuration message sent to each corresponding peripheral smart board cards 20
11. Configuring each of the peripheral smart board card(s) 20;
12. Testing each body part;
13. Testing the patient-simulating mannequin; and
14. Running the simulation.

Functions and simulation features of the patient-simulating mannequin 100 are uploaded in the main smart board card 10, and distributed to the various peripheral smart boards cards 20 in communication therewith in the selected body parts modules. The main smart board card 10 controls the execution of the simulation, while the peripheral smart board cards 20 execute the simulation. Each peripheral smart board card 20 executes a subset of functionalities corresponding to the body part module in which it is integrated. The peripheral smart board cards 20 and the main smart board card 10 may further communicate with sensors. Sensors are located in and/or on the patient-simulating mannequin 100 and are connected to the main smart board card 10 and/or to the peripheral smart board card 20, transmitting collected data to the main smart board card 10. The following table provides a list of functions, which may be performed by the patient-simulating mannequin 100, through the main smart board card and the peripheral smart board cards of the body part modules. The following functions may be performed singly or in combination, depending on the simulation scenario and/or the physiological function and/or pathology to be simulated:

| | |
|---|---|
| External Cephalic | External cephalic version can be performed on the |
| Version | patient-simulating mannequin to rotate a simulation fetus in a |
| | simulated uterus. |
| Mobile Fetal Heart | Simulated fetal heart sounds emanation source changes |
| Sounds | appropriately with a simulation fetal delivery progress. For |
| | instance, location where the simulation fetal heart can be |
| | heard will change as the simulation fetus descends and |
| | rotates to more properly reflect reality. |
| Anatomically | The patient-simulating mannequin's pelvis may be of |
| Correct Maternal | gynecoid shape and have anatomically correct |
| Pelvis | dimensions and the following palpable landmarks: pubic |
| | bone and ischial spines. |
| Palpable Simulated | Simulated uterine contractions can be detected by |
| Uterine | palpating the fundus. |
| Contractions | Time interval between simulated uterine contractions may |
| | vary from 10 minutes to 1 minute with less than 4 minutes |
| | during simulated normal labor. Each simulated contraction |
| | lasts between 30 to 90 seconds with an average of about |
| | 1 minute. Simulated contraction generates between 20 to |
| | 60 mm of mercury (Hg) of simulated amniotic fluid |
| | pressure with an average of about 40 mm of mercury |
| | (Hg). |
| | Hypercontactility refers to a smaller than 2 minutes |
| | interval between simulated contractions or simulated |
| | contractions lasting more than 2 minutes (hypertonus |
| | uterus). |
| | “Rock-hard” uterus refers to a simulated contraction |
| | above a predetermined. |
| Cervix | The patient-simulating mannequin may have a cervix that |
| | can be assessed by vaginal examination. Various stages |
| | of simulated dilation (0 to 10 cm) and simulated |
| | effacement (from 0% to 100%) are represented. |
| Fetal Heart Sounds | The patient-simulating mannequin may produce simulated |
| | fetal heart sounds that are audible by auscultation. |
| Fetal Descent and | The simulated fetus may be delivered by an active |
| Rotation | mechanism that properly responds to maneuvers used to |
| | assist delivery. |
| Suprapubic | The patient-simulating mannequin can withstand the |
| Pressure Support | application of simulated suprapubic pressure to simulate |
| | relieve shoulder dystocia. |
| McRoberts | The patient-simulating mannequin may detect the correct |
| Maneuver | execution of simulated McRoberts maneuver to resolve |
| Detection | shoulder dystocia. |
| Rubin II maneuver | The patient-simulating mannequin may support |
| Support | application of the simulated Rubin II maneuver to resolve |
| | shoulder dystocia. |
| Wood's Screw | The patient-simulating mannequin may support the |
| Maneuver Support | application of the simulated Wood's screw maneuver. |
| Postpartum Vaginal | The patient-simulating mannequin can be made to |
| Bleeding | simulate bleeding from the vagina after delivery of the |
| | simulated fetus. |
| Episiotomy | Episiotomy can be performed on the patient-simulating |
| | mannequin. |
| Intrapartum Vaginal | The patient-simulating mannequin can be made to |
| Bleeding | simulate bleeding from the vagina while simulating labor. |
| Delivery of the | The patient-simulating mannequin may support the |
| Posterior Arm | simulated delivery of the simulated fetus' posterior arm to |
| | resolve simulated shoulder dystocia. |
| Wood's Screw | The patient-simulating mannequin may detect proper |
| Maneuver | application of the simulated Wood's screw maneuver. |
| Detection | |
| Detection of | The patient-simulating mannequin may detect and |
| Rotational | measure the simulated rotational maneuvers performed |
| Maneuvers | by the care provider. |
| Breech Delivery, | A simulated vaginal or C-Section breech delivery can be |
| Frank and | performed with the patient-simulating mannequin for |
| Complete | simulating frank and complete breech. |
| Caesarean Section | Simulated simplified Caesarean Section can be performed |
| | on the patient-simulating mannequin. Simplified indicates |
| | that the patient-simulating mannequin does not support |
| | the surgical act of cutting through the abdomen and the |
| | fundus. Only an appropriate opening needs to be provided |
| | in the torso of the patient-simulating mannequin to allow |
| | the obstetrician to simulate pulling out the simulated fetus |
| | and the simulated placenta. |
| Suprapubic | The patient-simulating mannequin may detect the proper |
| Pressure Detection | application of simulated moderate suprapubic pressure to |
| | resolve simulated shoulder dystocia. |
| Zavanelli Maneuver | The patient-simulating mannequin detects the execution |
| Detection | of simulated Zavanelli maneuver. |
| Rubin II Maneuver | The patient-simulating mannequin may detect proper |
| Detection | application of the simulated Rubin II maneuver. |
| Breech Delivery, | A simulated C-Section breech delivery can be performed |
| Single and Double | with the patient-simulating mannequin for simulating |
| Footling | single and double footling breech presentation. |
| Childbirth | The patient-simulating mannequin may provide a |
| Breathing Pattern | simulated childbirth supportive breathing pattern: |
| | simulated high respiratory rate on simulated contraction. |
| Chest Excursion, | The patient-simulating mannequin's chest may move |
| Asymetric | asymmetrically while simulating breathing. |
| CPR Analysis | The patient-simulating mannequin shall analyze simulated |
| | chest compression. |
| Spontaneous | The patient-simulating mannequin may be able to |
| Breathing | simulate spontaneously breathing to a given respiratory |
| | rate exhibiting appropriate perceptible cues. |
| Normal Breathing | The patient-simulating mannequin can provide a |
| Pattern | simulated normal breathing pattern. |
| International | The patient-simulating mannequin can comply with the |
| Operation | regulatory requirements. |
| IV Therapy Support | The patient-simulating mannequin can simulate receiving |
| | IV Therapy. |
| Right Mainstem | The patient-simulating mannequin can detect simulated |
| Intubation | right main stem intubation when an endotracheal tube is |
| Detection | inserted. |
| Intubation | The patient-simulating mannequin can detect proper |
| Detection | simulated intubation. |
| CTG MNIBP UI | The emulated Cardiotocography (CTG) can provide |
| | control over the display of the Maternal Non-Invasive |
| | Blood Pressure (MNIBP). |
| CTG TOCO ZERO | The emulated CTG can provide a Tocodynamometer |
| UI | (TOCO) Zero reset capability. |
| Deformable Fetal | The simulated fetal head can deform realistically under |
| Head | pressure. |
| CTG Historical | The patient-simulating mannequin can provide a |
| Data Generation | mechanism whereby relevant CTG related data just |
| | anterior to a scenario start is generated. |
| Fetal Airway | The simulated fetal nose and mouth may accommodate |
| Suctioning | suctioning. However there is no need to actually suction |
| | fluids. |
| Fetal Spiral Scalp | A spiral Electrocardiogram (ECG) electrode can be |
| Electrode | attached to the simulated fetal scalp. |
| Placement | |
| Trendelenberg | The patient-simulating mannequin can detect |
| Detection | Trendelenberg positioning. |
| Fetal Applied | An instructor interface can dynamically display information |
| Torque Display | on the torque forces applied by the trainee to the head |
| | and neck of the simulated fetus. |
| Umbilical Cord | The simulated fetus has a realistic umbilical cord that may |
| | be positioned as prolapsed or nuchal and can be cut. |
| Pulses, Brachial | The patient-simulating mannequin may have bilateral |
| | brachial simulated pulses. |
| Breath Sounds | The patient-simulating mannequin's breathing can be |
| | made audible for auscultation. The simulated breath |
| | sounds are synchronized with the simulated respiratory |
| | cycle and have an audible volume control. Simulated |
| | sounds can be positioned across one or more of the |
| | following sites: |
| | Bronchial, Right/Left - 2 channels, 2 sites (shares upper |
| | heart sound speakers); |
| | Bronchovesicular, Right/Left Upper Posterior - 2 |
| | channels, 4 sites; |
| | Vesicular, Right/Left Upper Anterior - 2 channels, 4 sites; |
| | Vesicular, Right/Left Lower Anterior - 2 channels, 4 sites; |
| | Vesicular, Right/Left Lower Posterior - 2 channels, 4 |
| | sites; and |
| | Bronchovesicular, Sternum - 1 channel, 1 site. |
| CTG Control UI | An Emulated CTG can provide a set of controls that |
| | allows its user to direct its operation. |
| Alarm Control UI | The emulated CTG can provide the capability to set, clear, |
| | and control alarms on simulated physiological data. |
| CTG Paper strip | The emulated CTG shall provide the capability to display |
| | on screen a reproduction of the paper strip produced by |
| | real CTG with Fetal Heart Rate (FHR) and optional |
| | Maternal Heart Rate (MHR) graphs in a top grid part, |
| | Uterine Activity (UA) graph in a lower grid part. |
| CTG Alarms | The emulated CTG shall provide the capability to set and |
| | trigger alarms for out of stated bounds simulated |
| | physiological data. |
| Vocalization, Live | The patient-simulating mannequin can mix-in simulated |
| | vocalization sounds, simulated speech and vocal sounds |
| | created live by an operator via wireless microphone. |
| | Simulated live speech and sounds are subjected only to |
| | the simulated vocalization adjustable volume control. |
| | Simulated live speech and sounds are not disabled by |
| | apnea or loss of consciousness or repeated based on a |
| | simulated specified pattern. |
| Urinary | The patient-simulating mannequin has a simulated urinary |
| Catheterization | bladder that can be filled with fluid and catheterized. |
| Blinking | The patient-simulating mannequin may simulate eyes |
| | blinking. |
| Vocalization, | The patient-simulating mannequin can produce factory- |
| Canned | supplied, prerecorded speech and vocal sounds localized |
| | to one or several given language(s). |
| Vocalization, | The patient-simulating mannequin may produce user- |
| Custom | supplied, prerecorded speech and vocal sounds. |
| Positive Pressure | The patient-simulating mannequin can be mechanically |
| Ventilation | ventilated, simulating realistic airway/bronchial resistance, |
| | lung/chest compliance, and chest excursion. The patient- |
| | simulating mannequin may also detect ventilation. |
| Reactive Pupils | The patient-simulating mannequin's pupils can be set to |
| | fixed size or made to react automatically to light. |
| Left Lateral Tilt | The patient-simulating mannequin can detect positioning |
| Detection | in a left lateral tilt position. |
| Sphygmomanometry | The patient-simulating mannequin's simulated blood |
| | pressure can be evaluated by sphygmomanometry. |
| Pulses, Radial | The patient-simulating mannequin can simulate bilateral |
| | radial pulses. |
| Pulses, Carotid | The patient-simulating mannequin can simulate bilateral |
| | carotid pulses. |
| SpO2 Probe | A simulated SpO2 finger probe can be mechanically |
| | and/or electrically placed on the patient-simulating |
| | mannequin, enabling the display of optoplethysmography |
| | data on a simulated patient monitor. |
| Seizure | The patient-simulating mannequin can simulate seizure: |
| | simulated arm, eye and jaw movements, and simulated |
| | stertorous inhalation. |
| Custom | A Simulated Clinic Experiences (SCE) system may |
| Vocalizations SCE | maintain vocalization integrity of exported SCE that uses |
| Support | custom vocalization. |
| Patient-simulating | The patient-simulating mannequin may accept events as |
| mannequin Script | conditional trigger within a scenario script. |
| Trigger | |
| Scripted Fetal | The patient-simulating mannequin can provide scripted |
| Descent and | control over simulated fetal descent and rotation. |
| Rotation | |
| CPR Effectiveness | An instructor interface can provide simulated |
| Assessment | Cardiopulmonary Resuscitation (CPR) effectiveness |
| | analysis. |
| Patient-simulating | The instructor interface may be extended to capture the |
| mannequin Data | evolution over time of the patient-simulating mannequin |
| Logging | specific simulated physiological and training data for later |
| | debriefing and analysis. |
| Patient-simulating | The instructor interface may be extended to log |
| mannequin Event | notification events for the patient-simulating mannequin |
| Logging | specific conditions or change of states. |
| Fetal Applied | The instructor interface may dynamically display |
| Traction Display | information on the traction forces applied by a trainee |
| | (user of the patient-simulating mannequin) to the head |
| | and neck of the simulated fetus. |
| 12-Lead ECG | A maternal patient monitor may provide 12-Lead ECG |
| Report | reporting capabilities. |
| IV Access, | Intravenous cannulas can be introduced into the simulated |
| Forearm | veins of the forearm of the patient-simulating mannequin. |
| APGAR Score | The physiological models of the patient-simulating |
| | mannequin may generate Appearance, Pulse, Grimace, |
| | Activity, Respiration (APGAR) scores for the newly born |
| | simulated fetus. |
| CTG User | The emulated CTG shall provide the capability to locally |
| Configuration UI | set some behavioral aspects. |
| CTG Configuration | The patient-simulating mannequin can provide the |
| UI | capability to configure the operation and the look of the |
| | emulated cardiotocograph (CTG). |
| Articulated Fetal | The simulated fetal body may articulate realistically for the |
| Body | following joints: neck, shoulders, elbows, hips and knees. |
| Postpartum | The instructor interface can provide control over simulated |
| Hemorrhage UI | post-partum vaginal bleeding. |
| Neonate Crying UI | The instructor interface can provide control over simulated |
| | neonate crying. |
| Maternal Heart UI | The instructor interface can provide control over the |
| | simulated patient-simulating mannequin's heart |
| | parameters; e.g. simulated cardiac rhythms and heart |
| | sounds. |
| Fetal Soft Tissue | The simulated fetal body may be realistically pliable such |
| | that it is possible to differentiate between simulated |
| | cephalic and simulated breech delivery. |
| Pulses UI | The instructor interface can provide control over simulated |
| | pulses settings. |
| Audible Breathing | The instructor interface can provide control over simulated |
| UI | audible breathing settings. |
| Breath Sounds UI | The instructor interface can provide control over simulated |
| | breath sounds settings. |
| Chest Excursion UI | The instructor interface can provide the capability to |
| | control operation of the simulated chest excursion |
| | mechanism. |
| Seizure UI | The instructor interface can provide the capability to |
| | control operation of the simulated seizure. |
| Eye Control UI | The instructor interface can provide control over the |
| | patient-simulating mannequin's eyes operation. |
| Vocalization UI | The instructor interface can provide control over the |
| | simulated vocalization playback parameters. |
| Emulated | The patient-simulating mannequin may further include an |
| Cardiotocograph | emulated cardiotocograph that provides the most common |
| | features found on typical real CTG monitors. It is not |
| | intended to reproduce a specific make and model of a |
| | CTG or have all possible features. It displays simulated |
| | mother and simulated fetus physiological data as numeric |
| | values along with an on-screen reproduction of the paper |
| | strip produced by real CTG printer. |
| | The emulated CTG is Software only and does not include |
| | any specific hardware such as simulated probes. The |
| | trainee can always install and connect probes on the |
| | patient-simulating mannequin. Proper placement of these |
| | probes could be evaluated by the instructor or by sensors |
| | in the patient-simulating mannequin. |
| Live vocalization UI | The instructor interface may provide control over the |
| | simulated live vocalization parameters. |
| Laboratory Results | The instructor Interface can support use of laboratory |
| UI | results within a simulated training session. |
| Physiological Data | The instructor interface may display selected additional |
| Display | patient-simulating mannequin physiological data values. |
| ECG Signals | The instructor interface can display up to 12-Lead ECG |
| Display | signals; e.g. all of 3-Lead, 5-Lead and 12-Lead traces are |
| | available. |
| Caesarean | A simulated high fidelity cesarean section can be |
| Section, High | performed on the patient-simulating mannequin. |
| Fidelity | |
| Patient-simulating | The instructor interface may include historical data |
| mannequin Related | management capability adapted to manage the patient- |
| Historical Data | simulating mannequin related data. |
| Instructor interface | The instructor interface may support the patient-simulating |
| Patient-simulating | mannequin. |
| mannequin Support | |
| Operation Mode UI | The instructor interface may provide control and |
| | visualization over the operating mode of the patient- |
| | simulating mannequin. |
| Fetal Heart Sounds | The Instructor Interface may provide control over the |
| UI | simulated fetal heart sounds. |
| Cervix UI | The instructor interface may provide control and |
| | visualization over the simulated cervix operation. |
| Shoulder Dystocia | The instructor interface can provide control over simulated |
| UI | shoulder dystocia. |
| Fetal Descent and | The instructor interface may provide control and |
| Rotation UI | visualization over simulated fetal descent and rotation. |
| Exhalation | The patient-simulating mannequin can simulate exhaling |
| | air (or any other inhaled gaz) such that it minimally |
| | provides required cues to stimulate ventilator. |
| Chest | The patient-simulating mannequin may detect and |
| Compression | properly react when chest compression is applied. |
| Detection | |
| Chest | Chest compressions can be performed on the patient- |
| Compression | simulating mannequin. |
| Emulated Maternal | The patient-simulating mannequin can provide an |
| Patient Monitor | emulated patient monitor for the simulated maternal vital |
| | signs. |
| Airway | The patient-simulating mannequin may have an |
| | anatomically correct airway. |
| Electrical Therapy | The patient-simulating mannequin can be paced, |
| | cardioversed and defibrillated. |
| Audible Breathing | The patient-simulating mannequin's breathing can be |
| | made audible for unaided listening. The simulated |
| | breathing sound may be synchronized with the simulated |
| | respiratory cycle and may have an audible volume |
| | control.. |
| 5-Lead ECG, Real | A real 5-lead electrocardiograph can be connected to the |
| | patient-simulating mannequin. It includes the capability to |
| | connect a real 3-Lead electrocardiograph. |
| Heart Sounds | The patient-simulating mannequin may produce realistic |
| | simulated heart sounds associated with a variety of |
| | simulated conditions at 4 precordial auscultation areas. |
| | Each of the 4 auscultation sites may be independently |
| | controllable. |
| Catheterization | The patient-simulating mannequin may provide an |
| Immediate Urine | immediate urinary output upon catheter insertion. |
| Output | |
| IV Access, Dorsal | Intravenous cannulas can be introduced into the simulated |
| Hand | veins of the dorsum of the hand of the patient-simulating |
| | mannequin. |
| Laboratory Results | The patient-simulating mannequin may provide a |
| | mechanism whereby patient laboratory results can be |
| | communicated. |
| Chest Excursion, | The patient-simulating mannequin's chest can rise and fall |
| Spontaneous | with simulated spontaneous breathing. |
| IV Drug | Intravenous drugs administered to the patient-simulating |
| Recognition | mannequin may be automatically detected. |
| Fraction of Inspired | The patient-simulating mannequin can sense and |
| Oxygen Sensing | measure the amount of oxygen provided. |
| Rectum | The patient-simulating mannequin can have an anal |
| | sphincter and rectal cavity for administration of some |
| | amount of medecine (micro-enema and suppository). |
| Epidural | The patient-simulating mannequin may support the |
| | epidural procedure. |
| Articulated | The patient-simulating mannequin may provide an |
| Maternal Body | articulated maternal full-body to allow a variety of |
| | simulated birthing positions: |
| | interventions for delivery complications; |
| | interventions for maternal emergencies; and |
| | realistic patient transport. |
| Leopold's | Leopold's maneuvers can be performed on the patient- |
| Maneuvers | simulating mannequin to determine the position and lay of |
| | the simulated fetus in the patient-simulating mannequin's |
| | uterus and to estimate simulated fetal weight. |
| Vagina | The patient-simulating mannequin can have a realistic |
| | birth canal. |
| Vulva/Perineum | The patient-simulating mannequin can have external |
| | female genitalia and perineum. Furthermore, the patient- |
| | simulating mannequin may provide an intact perineum |
| | and a perineum for episiotomy. |
| Zavanelli maneuver | Zavanelli maneuver can be applied to the patient- |
| Support | simulating mannequin. |
| Postpartum Uterus | The patient-simulating mannequin can have a palpable |
| | postpartum uterus. |
| Inverted Uterus | The patient-simulating mannequin can be configured with |
| | a fully or partially inverted uterus. |
| Intact Placenta | The patient-simulating mannequin may support placenta |
| | delivery in an intact state. |
| Fragmented | The patient-simulating mannequin may support placenta |
| Placenta | delivery in a fragmented state. |
| Palpable Fontanels | Anterior and posterior fontanels and the sagittal suture |
| and Sagittal Suture | may be palpable on the simulated fetal head. |
| Forceps | Forceps can be applied to the simulated fetus to assist |
| Application | delivery. |
| Vacuum Extractor | A vacuum extractor can be applied to the simulated fetus |
| Application | to assist delivery. |
| Physiological | The patient-simulating mannequin may include |
| Models | physiological models for the mother and the fetus. |
| Untethered | The patient-simulating mannequin can operate |
| Operation | untethered. |
| Crying | The simulated neonate fetus is capable of simulating |
| | cries. |
| Fetal Head Torque | The patient-simulating mannequin may sense the |
| Sensing | magnitude of torque applied by the trainee on the |
| | simulated fetal head and indicate when excessive force is |
| | used. |
| Fetal Neck Traction | The patient-simulating mannequin may sense the |
| Sensing | magnitude of a traction force applied by the trainee on the |
| | simulated fetal head and indicate when excessive force is |
| | used. |

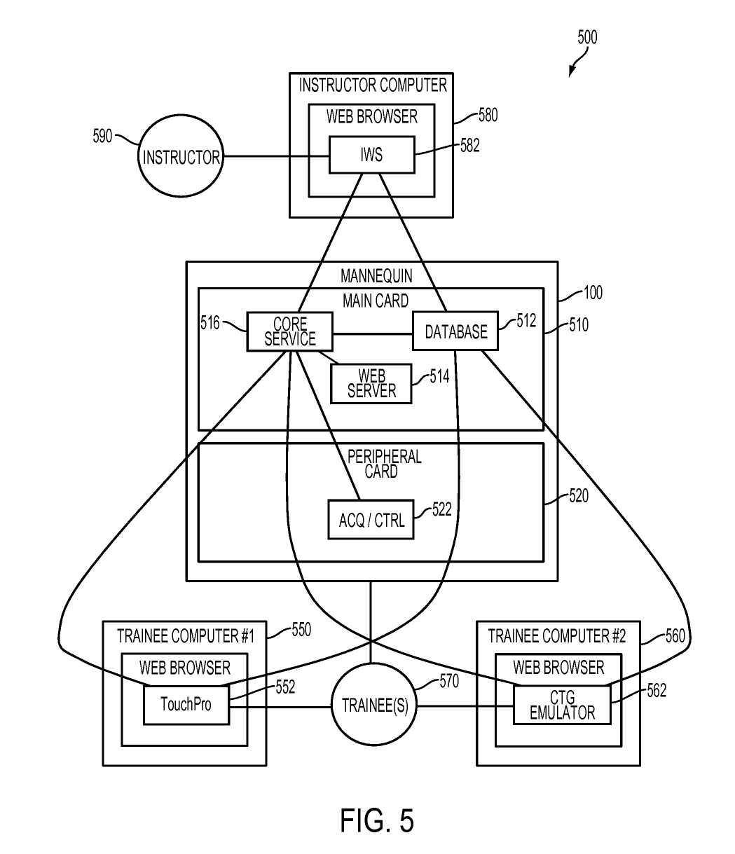

Referring now to FIG. 5, there is shown a block diagram of an example of a simulation system 500. The simulation system 500 comprises a patient-simulating mannequin 100, a server component (shown as web server 514) and a plurality of client components (582, 552 and 562). As previously mentioned, the server component 514 may reside in a main smart board card 510 of the patient-simulating mannequin 100, or be located separately from the main smart board card 510. All the client components (582, 552 and 562) run at different hosts (respectively 580, 550 and 560) such as a desktop computer, a laptop computer, a tablet or handheld mobile device, which may access the main smart board card 510 of the patient-simulating mannequin 100. For example, the simulation system 500 comprises an instructor computer 580 (operated by an instructor 590) and two trainee computers 550 and 560 (operated by trainee(s) 570), each of the computers running a client component.

In the example provided in FIG. 5, the patient-simulating mannequin 100 comprises one main smart board card 510 and one peripheral smart board card 520, connected via a wired/wireless connection. The patient-simulating mannequin 100 may comprise additional main smart board card(s) 510 not represented in FIG. 5. The patient-simulating mannequin 100 may also comprise additional peripheral smart board card(s) 520 not represented in FIG. 5. As previously discussed, the peripheral smart board cards (e.g. 520) monitor and control various features of the body-part modules in which it is part of, such as for example: simulated pulses, simulated chest movement, simulated bleeding, etc. In this example, a server component may reside on the main smart board card 510. It may consist of a database 516 for simulation contents storage, a web server 514 for contents retrieval, and a core service 516 for real time data generation. Also, in this example, an acquisition and control software 522 (implementing sensor data acquisition and actuator control) resides on the peripheral smart board card 520. The main smart board card 510 transmits commands to the peripheral smart board card 520, to implement the features of the corresponding body-part module under the control of the peripheral smart board card 520. The main smart board card 510 receives simulation data from the peripheral smart board cards 520.

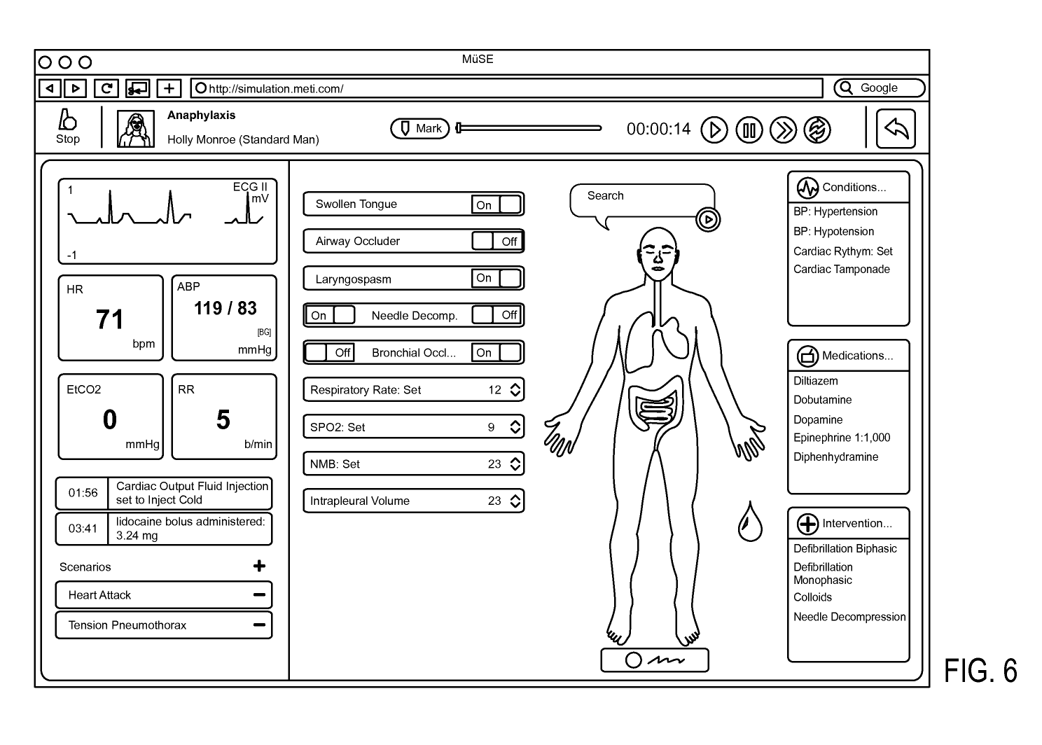

The client components consist of software applications, and provide a User Interface (UI) application, for example a TouchPro application 552 executed on the trainee computer 550 and a Cardiotocograph (CTG) monitor application 562 executed on the trainee computer 560. The client components provide users with a visualization of some aspects of an undergoing simulation. This is exemplified in FIG. 6, which is a graphical representation of an instructor UI application to access and transmit data from and to the patient-simulating mannequin 100. The UI application of the client components interfaces with the main smart board card 510 and provides simulation controls such as start and stop a simulation. The UI application of the client components is designed for instructor access. The TouchPro application 552 provides waveform and vital sign display to the trainee(s) 570. In the case of a maternal simulator, the CTG emulator 562 specifically provides monitoring of a fetus to the trainee(s) 570. All client components can be web-based. Therefore, no installation is required at the client side except obtain access to the web server 514.

Educational contents are represented as simulated clinic experiences (SCEs). A SCE definition includes a patient that is defined by various physiologic parameters and multiple scenarios that simulate medical conditions. SCEs are stored in the database 512 of the web server component 514 (on the main smart board card 510). The system Core service 516 is a core application that provides mathematical simulation of the physiologic models and generates real-time physiologic data to feedback to all client components (582, 552 and 562).

During a simulation session, the functions and parameters of the patient-simulating mannequin 100 may be accessed by the instructor 590, through the client component (Instructor Workstation (IWS) 582) executed by the web browser or alternatively by another software application, to emulate medical monitoring equipment for the trainee(s) 570.

In the case of a childbirth delivery simulation scenario, the patient-simulating mannequin 100 can present situations that occur, for example, during pregnancy, labor, delivery, and postpartum period. Both vertex (head-first) and breech (buttocks-first) vaginal deliveries can be simulated, as well as Caesarean section.

The patient-simulating mannequin 100 is driven by computational models of physiology, scenarios and collection of state machines stored in the memory of the main smart board card or the remote server depending on the implementation, and modifiable by the instructor 590 through the instructor computer 580. The patient-simulating mannequin 100 detects interventions performed by the trainee(s) 570, which are recorded and may trigger changes to the simulation. For example, the detected intervention may include any type of intervention that may be detected by means of one of several sensors in the various body parts of the patient-simulating mannequin, such as for example traction applied to assist delivery of the fetus, the magnitude of which is quantified.

A simulation may involve the following steps, where some of the steps may be omitted, skipped, interchanged, or realized in a different order:
1. The core service component 516 starts and sets up a transmission control protocol (TCP) server 514 for client component (582, 552 and 562) connections;
2. The instructor 590 opens a web browser on the instructor computer 580 and types in a Uniform Resource Locator (URL) corresponding to the server side 514 of the web server;
3. A Flash™ object is loaded to the IWS 582 and starts to communicate with the web server 514 via hypertext preprocessor (PHP) common gateway interface (CGI);
4. The Flash™ object accesses the database 512 via PHP, fetches the Educational contents, and displays the Educational contents in the web browser of the instructor computer 580;
5. The instructor 590 starts a simulation;
6. The Flash™ object starts to communicate with the core service 516 and conducts commands to the core service 516;
7. The Core service 516 accesses the database 512 to fetch the educational contents and feed the mathematical model;
8. The simulation begins for the trainee(s) 570;
9. Trainee(s) 570 stay close to the simulator and monitor the physiologic signals via either TouchPro 552 or CTG 562;
10. The instructor 590 adjusts parameters of the patient-simulating mannequin via UI, or load scenarios from the database 512, via web server 514, into the simulation effectuated by the patient-simulating mannequin;
11. The Flash™ object conducts all commands to the core service 516;
12. The simulation continues based on the adjusted parameters provided by the instructor;
13. The trainee(s) 570 check physiological aspects (for example: pulse, perform CPRs, check eye blinking, etc) displayed by the patient-simulating mannequin;
14. Interventions done by trainee(s) 570 are fed back to the core service 516 to drive the models;
15. The core service component 516 constantly feeds data to all client components (TouchPro 552 or CTG 562), and save simulation results and logs into the database 512;
16. The instructor 590 stops/pauses the ongoing simulation; and
17. The Flash™ object sends the command to the core service 516, and simulation stops/pauses.

A typical simulation command involves the following steps, where some of the steps may be omitted, skipped, interchanged, or realized in a different order:
1. The instructor 590 clicks on a heart control button on the User Interface of the Instructor Computer;
2. The instructor 590 sets the Heart Rate to 120 using a User Interface text field or slider on the display of the instructor computer;
3. The Flash™ object wraps a “set HR 120” command into a certain format and sends it to the core service 516;
4. The core service 516 gets the command and makes it into a data block in an internal memory;
5. The running model picks up the new data and drives the simulation; and
6. The core service 516 logs the action/simulation results into the database 512.

The simulator system 500 may be self-contained. The server components only access information on the patient-simulating mannequin 100. The client components, as per the nature of a web application, do not access the information on a client host machine without further authentication.

Those of ordinary skill in the art will realize that the description of the modular patient-simulating mannequin and method of assembly therefor are illustrative only and are not intended to be in any way limiting. Other embodiments will readily suggest themselves to such persons with ordinary skill in the art having the benefit of the present disclosure. Furthermore, the disclosed patient-simulating mannequin and method of assembly therefor may be customized to offer valuable solutions to existing needs, physiologic models and medical training scenarios. Therefore, body parts can be interchanged with others to offer different functionalities.

In the interest of clarity, not all of the features of the patient-simulating mannequin and method of assembly therefor are shown and described. It will, of course, be appreciated that in the development of any such patient-simulating mannequin and method of assembly therefor, numerous implementation-specific decisions may need to be made in order to achieve the developer's specific goals, such as compliance with application, system, and business-related constraints, and that these specific goals will vary from one implementation to another and from one developer to another. Moreover, it will be appreciated that a development effort might be complex and time-consuming, but would nevertheless be a routine undertaking of engineering for those of ordinary skill in the field of biomedical engineering having the benefit of the present disclosure.

Although the present disclosure has been described hereinabove by way of non-restrictive, illustrative embodiments thereof, these embodiments may be modified at will within the scope of the appended claims without departing from the present claims.

What is claimed is:

1. A patient-simulating mannequin comprising:
at least one main smart board card for operating the patient-simulating mannequin, the smart board card storing simulation scenarios to be used with the patient-simulating mannequin; and
at least one body part module, the at least one body part module being removable from the patient-simulating mannequin, the at least one body part module having at least one peripheral smart board card in communication with the main smart board card, the at least one peripheral smart board card being configurable by the at least one main smart board.

2. The patient-simulating mannequin of claim 1, wherein the removable body part module is a head module.

3. The patient-simulating mannequin of claim 2, wherein the at least one main smart board card is located in the torso module.

4. The patient-simulating mannequin of claim 2, wherein the torso module is in mechanical and/or electrical connection with an airway module, the airway module comprising at least one peripheral smart board card in communication with the main smart board card.

5. The patient-simulating mannequin of claim 4, wherein the airway module is in mechanical and/or electrical connection with a head module, the head module comprising at least one peripheral smart board card in communication with one of the main smart board card and the at least one peripheral smart board card located in the airway module.

6. The patient-simulating mannequin of claim 5, wherein the torso module is in mechanical and/or electrical connection with a removable arm module, the removable arm module comprising at least one peripheral smart board card in communication with one of the main smart board card and the at least one peripheral smart board card located in the torso module.

7. The patient-simulating mannequin of claim 5, wherein the torso module is in mechanical and/or electrical connection with a pelvic module, the pelvic module comprising at least one peripheral smart board card in communication with one of the at least main smart board card and the at least one peripheral smart board card located in the torso module.

8. The patient-simulating mannequin of claim 7, wherein the pelvic module is in mechanical and/or electrical connection with a removable leg module, the removable leg module comprising at least one peripheral smart board card in communication with one of the main smart board card and the at least one peripheral smart board card located in the pelvic module.

9. The patient-simulating mannequin of claim 1, wherein the at least one peripheral smart board card and the at least one main smart board card are in communication via an Ethernet connection.

10. The patient-simulating mannequin of claim 1, wherein the at least one peripheral smart board card and the at least one main smart board card are in wireless communication using radio waves.

11. The patient-simulating mannequin of claim 1, wherein the at least one main smart board card comprises:
at least one memory for storing a database including simulation scenarios and instructions;
at least one processor for accessing the database and operating the patient-simulating mannequin according to the simulation scenarios and instructions; and
an input/output unit for exchanging data with at least one of: a peripheral smart board card and an external device.

12. The patient-simulating mannequin of claim 11, wherein exchanging data with an external device comprises exchanging data with a mobile device.

13. The patient-simulating mannequin of claim 5, wherein the torso module comprises a removable childbirth mechanism to deliver a fetal simulator.

14. The patient-simulating mannequin of claim 1, wherein the at least one peripheral smart board card comprises:
at least one memory for storing a configurable simulation code;
at least one processor for executing the configurable simulation code; and
a configurable input/output unit for exchanging data with at least one of: the at least one main smart board card and an external device, the configurable input/output unit being configured by the at least one processor in accordance with a configuration message received from the main smart board card.

15. The patient-simulating mannequin of claim 14, wherein exchanging data with an external device comprises exchanging data with at least one of a sensor and an actuator.

16. The patient-simulating mannequin of claim 14, wherein the at least one main smart board card exchanges configuration messages with the at least one peripheral smart board card for configuring the configurable input/output unit and the configurable simulation code executed by the processor of the at least one peripheral smart board card.

17. The patient-simulating mannequin of claim 16, wherein the at least one peripheral smart board card further comprises a configurable power supply, and the at least one main smart board card exchanges configuration messages with the at least one peripheral smart board card for configuring the configurable power supply of the at least one peripheral smart board card.

18. The patient-simulating mannequin of claim 14, wherein the at least one memory further stores a testing software and the at least one processor executes the testing software for monitoring that the configurable input/output unit and the configurable simulation code executed by the processor are operating according to their configuration.

19. The patient-simulating mannequin of claim 18, wherein the results of the tests performed by the testing software are transmitted to the at least one main central board card.

20. A method for assembling a patient-simulating mannequin, the method comprising:
selecting a physiologic model;
selecting a simulation scenario;
determining removable body parts required to reproduce the physiologic model and run the simulation scenario;
selecting removable body parts required to run the simulation scenario, each body parts including a peripheral smart board card, and one of the selected removable body parts further including a main smart board card;
mechanically inter-connecting the selected removable body parts;
actuating the main smart board card;
actuating the peripheral smart board card of each body part;
configuring the peripheral smart board card of each body part by the main smart board card;
updating the content of the main smart board card; and
running the simulation.
